(19) United States
(12) Patent Application Publication
(10) Pub. No.: US 2025/0103281 A1
(43) Pub. Date: Mar. 27, 2025

(54) OCCUPANT ASSIST SYSTEM AND OCCUPANT ASSIST METHOD

(71) Applicant: TOYOTA JIDOSHA KABUSHIKI KAISHA, Toyota-shi (JP)

(72) Inventor: Daisuke JIMBO, Toyota-shi (JP)

(73) Assignee: TOYOTA JIDOSHA KABUSHIKI KAISHA, Toyota-shi (JP)

(21) Appl. No.: 18/812,359

(22) Filed: Aug. 22, 2024

(30) Foreign Application Priority Data
Sep. 26, 2023 (JP) 2023-163336

(51) Int. Cl. G06F 3/16; G06V 20/56; G06V 20/59

(52) U.S. Cl. CPC G06F 3/167; G06V 20/56; G06V 20/597

(57) ABSTRACT

An occupant assist system for assisting an occupant of a vehicle is configures to detect a target existing around the vehicle based on external environment data relating to an environment around the vehicle, detect a line-of-sight direction of the occupant based on occupant data representing a state of the occupant of the vehicle, specify a visual target viewed by the occupant based on the target and the line-of-sight direction of the occupant, acquire additional information related to the visual target when the type of the visual target is a building, and, based on a content of the occupant's voice when the occupant is looking at the visual target and additional information related to the visual target, specify a requirement of the occupant for the visual target and perform an action for addressing the requirement.

### FIELD

The present disclosure relates to an occupant assist system and occupant assist method.

### BACKGROUND

JP2002-267470A discloses a conventional information presentation system that presents information associated with a specific location outside a vehicle viewed by a driver of the vehicle through a windshield (for example, an advertisement of a store located at a specific location) to the driver.

### SUMMARY

However, the conventional information presentation system described above presents predetermined information stored in a database to the driver as information associated with the specific location. Therefore, in the conventional system, even if the driver had any requirement for the store that is visible through the windshield while driving, the system could not handle the requirement.

The present disclosure has been made focusing on the above problem, and an object thereof is to enable handle the requirement without making the driver stop driving when the driver had any requirement for the store that is visible through the windshield while driving.

To solve the above problem, an occupant assist system for assisting an occupant of a vehicle according to one aspect of the present disclosure is configured to detect a target existing around the vehicle based on external environment data relating to an environment around the vehicle, detect a line-of-sight direction of the occupant based on occupant data representing a state of the occupant of the vehicle, specify a visual target viewed by the occupant based on the target and the line-of-sight direction of the occupant, acquire additional information related to the visual target when the type of the visual target is a building, and, based on a content of the occupant's voice when the occupant is looking at the visual target and additional information related to the visual target, specify a requirement of the occupant for the visual target and perform an action for handling the requirement.

Further, an occupant assist method for assisting an occupant of a vehicle according to one aspect of the present disclosure includes detecting a target existing around the vehicle based on external environment data relating to an environment around the vehicle, detecting a line-of-sight direction of the occupant based on occupant data representing a state of the occupant of the vehicle, specifying a visual target viewed by the occupant based on the target and the line-of-sight direction of the occupant, acquiring additional information related to the visual target when the type of the visual target is a building, and, based on a content of the occupant's voice when the occupant is looking at the visual target and additional information related to the visual target, specifying a requirement of the occupant for the visual target and performing an action to handle the requirement.

According to these aspects of the present disclosure, when there is a requirement for a store that was visible while driving, a driver can handle the requirement for the store that is visible while driving by combining the line-of-sight direction and the content of the driver's own voice while driving.

### BRIEF DESCRIPTION OF DRAWINGS

FIG. 1 is a schematic view of an occupant assist system according to an embodiment of the present invention.

FIG. 2 is a view showing an example of an operation sequence of an occupant assist system according to an embodiment of the present disclosure.

### DESCRIPTION OF EMBODIMENTS

Below, referring to the drawings, an embodiment of the present disclosure will be explained in detail. Note that, in the following explanation, similar component elements will be assigned the same reference notations.

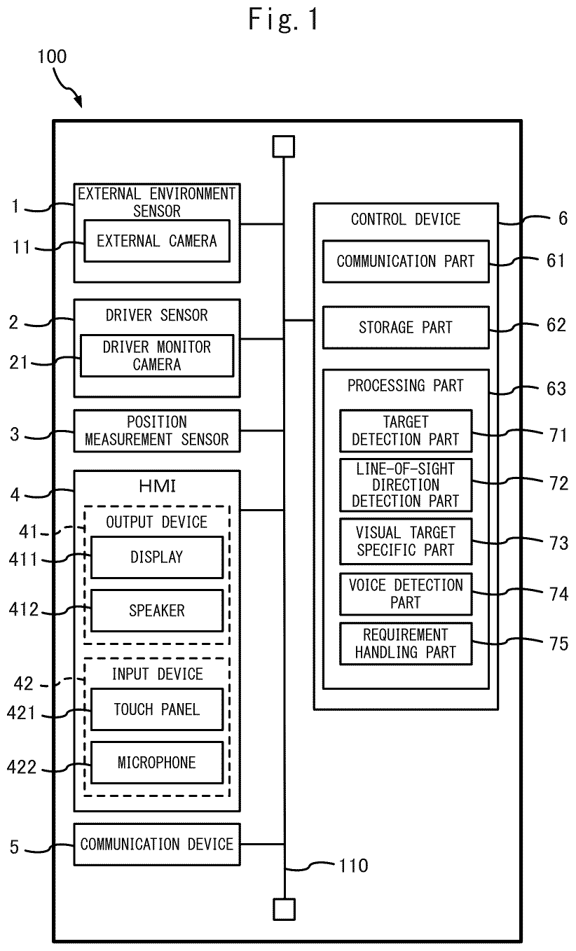

FIG. 1 is a schematic view of an occupant assist system 100 according to an embodiment of the present disclosure.

The occupant assist system 100 is a system for assisting the occupants of a vehicle while the vehicle is in motion. In this embodiment, an example in which the occupant assist system 100 is applied to the driver of the vehicle is described.

The occupant assist system 100 is provided with external environment sensors 1, driver sensors 2, a position measurement sensor 3, an HMI (human machine interface) 4, a communication device 5, a control device 6. The external environment sensors 1, driver sensors 2, position measurement sensor 3, HMI (human machine interface) 4, communication device 5, and control device 6 are connected to be able to communicate through an internal vehicle network 7 based on the standard such as Control Area Network and Automotive Ethernet.

The external environment sensors 1 generate data relating to the environment around the vehicle (hereinafter referred to as “external environment data”). In the present embodiment, as the external environment sensors 1, one or more external cameras 11 for capturing the surroundings of the vehicle including at least the area ahead of the vehicle are provided. The external cameras 11 capture the surroundings of the vehicle at a predetermined frame rate (for example, 10 Hz to 40 Hz) and generate surrounding images in which the surroundings of the vehicle are displayed. The external cameras 11 send the generated surrounding images as external environment data to the control device 6 each time the surrounding images are generated.

The driver sensors 2 generate data representing a state of the driver (hereinafter referred to as “driver data”). In the present embodiment, as the driver sensor 2, a driver monitor camera 21 for capturing an appearance of a driver including a driver's face is provided. The driver monitor camera 21 captures an appearance of the driver at a predetermined frame rate (for example, 10 [Hz] to 40 [Hz]) and generates driver appearance images in which the appearance of the driver is displayed. The driver monitor camera 21 sends the generated driver appearance images to the control device 6 as driver data via the internal vehicle network 110 each time the appearance images of the driver are generated.

The position measurement sensor 3 generates current position data showing the current position of the vehicle (hereinafter referred to as “current position data”) such as the longitude and latitude. The position measurement sensor 3 sends the generated current position data to the control device 6 via the internal vehicle network 110 each time the current position data is generated.

The HMI 4 is a user interface for transfer of information between the host vehicle and its occupants. The HMI 4 is provided with output devices 41 for providing notifications to the vehicle occupants through the physical senses of the vehicle occupants (for example, sight, hearing, touch, etc.) and input devices 42 for the vehicle occupants to perform input operations and response operations. In the present embodiment, as output devices 41, a display (for example, meter display, center display, heads-up display, etc.) 411 and speakers 412 are provided. As the input devices 42, a touch panel 421 and microphone 422 are provided.

The HMI 4 displays information corresponding to a display signal received from the control device 6 (for example, text information or graphic information) on the display 411 and outputs audio corresponding to an audio signal from the speakers 412. Further, the HMI 4 sends data input by the touch panel or input by voice by the vehicle occupant through the input devices 42 (below, referred to as the “passenger input data”) to the control device 6 via the internal vehicle network 110.

The HMI 4 may be mounted in the host vehicle in advance or may be a smartphone or other terminal held by the driver. In the latter case, for example, information may be transferred by short distance wireless between the host vehicle and terminal of the driver, the terminal of the driver and an outside server (not shown) may communicate with each other, and information may be transferred indirectly through the server.

The communication device 5 has a communication interface circuit for connecting to a network constituted by an optical communication line or the like, and is configured to connect a vehicle to, for example, an external server (not shown) or the like via the network so as to communicate with each other.

The control device 6 is an ECU (electronic control unit) provided with a communication part 61, storage part 62, and processing part 63.

The communication part 61 has a communication interface circuit for connecting the control device 6 to the internal vehicle network 110. The communication part 61 supplies the various data received from the sensors 1, 2, and 3, the HMI 4, the communication device 5, etc., to the processing part 63. Further, the communication part 61 outputs the various signals output from the processing part 63 to the HMI 4, the communication device 5, etc.

The storage part 62 has an HDD (hard disk drive), SSD (solid state drive), semiconductor memory, or other storage medium and stores various computer programs and data etc., used for processing at the processing part 63.

The processing part 63 has one or more CPUs (central processing units) and their peripheral circuits and runs various computer programs stored in the storage part 62. The processing part 63 is for example a processor. The processing part 63 performs processing in accordance with a computer program so as to function as a target detection part 71, line-of-sight direction detection part 72, visual target specific part 73, voice detection part 74, and requirement handling part 75 and operate as a function part (module) realizing a predetermined function. In the following explanation, if explaining the processing using the function parts 71 to 75 as subjects, it is indicated that the processing part 63 runs programs for realizing the function parts 71 to 75.

Below, the content of the specific processing performed at the control device 6 will be explained. That is, the content of the function parts 71 to 75 realized by the processing part 63 performing processing in accordance with the programs will be explained.

The target detection part 71 sequentially inputs the surrounding images received from the external camera 11 to a discriminator, thereby detecting, in surrounding images, an area in which targets such as other vehicles, pedestrians, and buildings are represented and the type of target represented in the area. The discriminator may be, for example, a convolutional neural network (CNN) having a plurality of convolutional layers connected in series from an input-side to an output-side. The target detection part 71 estimates the distance from the external camera 11 to the target by using the standard size of the target stored in the storage part 62 for each type of target and the size of the target detected in the surrounding image, and calculates the position and the speed of the target by tracking the target detected in the surrounding images in time series. Note that the method of detecting the target is not limited to such a method, and the target may be detected by various known methods.

The line-of-sight direction detection part 72 sequentially performs image processing on the driver appearance image (e.g., face image) of the driver received from the driver monitor camera 21, thereby detecting the position of the center of a pupil (that is, the viewpoint position of the driver) as the moving point and the position of the Purkinje image (the corneal reflection image) as the reference point, and detecting the line-of-sight direction of the driver based on the positional relationship between the Purkinje image and the center of the pupil (the position of the moving point with respect to the reference point). The method of detecting the line-of-sight direction of the driver is not limited to such a method, and it may be detected by various known methods.

The visual target specific part 73 specifies a target viewed by the driver (hereinafter referred to as a “visual target”) on the basis of the target around the vehicle and the line-of-sight direction of the driver. The visual target specific part 73 acquires additional information about the visual target as necessary. For example, in the present embodiment, if the type of the visual target is a building, the visual target specific part 73 acquires additional information on the visual target such as the name of the building, the name of the store in the building, the service content, and the like, based on the image of the visual target in the surrounding images, the current position data, the distance to the visual target, the map data stored in the storage part 62, and the like. Note that the visual target specific part 73 can also use the Internet via the communication device 5 to acquire additional information.

The voice detection part 74 detects a voice of the driver (vehicle occupant) via the microphone 422, and converts the voice into desired data (for example, text data of the driver's voice) that can be processed by the requirement handling part 75.

The requirement handling part 75 specifies a requirement of the driver using a learned machine learning model (AI) such as a neural network, and executes a requirement process for handling the requirement of the driver, based on the data of a content of the driver's voice, the visual target, and the additional information of the visual target. In specifying the requirement of the driver, for example, a driver's gesture (such as a pointing gesture or a predetermined gesture) that can be detected from the driver appearance image can be added to the judgement material.

The requirement process includes a process of searching a website of a store related to a visual target using the Internet, a process of browsing a specific page on the website of the store, a process of starting a dedicated application capable of reserving the store, a process of confirming various kinds of information on the store by the website or the dedicated application (for example, availability check), a process of reserving the store by the website or the dedicated application, a process of ordering the store from the website or the dedicated application, a process of making a telephone call to the store, and the like. In addition, the requirement process includes a notification process for notifying the driver (vehicle occupant) of the processing results of the respective process such as the above-described search process via the HMI 4.

In this way, the occupant assist system 100 according to the present embodiment specifies the requirements of the driver by using the visual target and the additional information thereof in addition to the content of the driver's voice. Therefore, even when the driver does not have information on the visual target such as the name of the store, the driver can easily handle various requirements (for example, availability check of the store that is visible through the windshield while driving, reservation of the store that is visible through the windshield while driving, browsing and ordering of the commodity of the store that is visible through the windshield while driving, telephone to the store that is visible through the windshield while driving, activation of an application related to the store that is visible through the windshield while driving, confirmation of information on the store that is visible through the windshield while driving, and the like) while driving by combining the line-of-sight direction and the content of the driver's voice (which is, for example, “Tell the menu of the store” or “Reserve the store”).

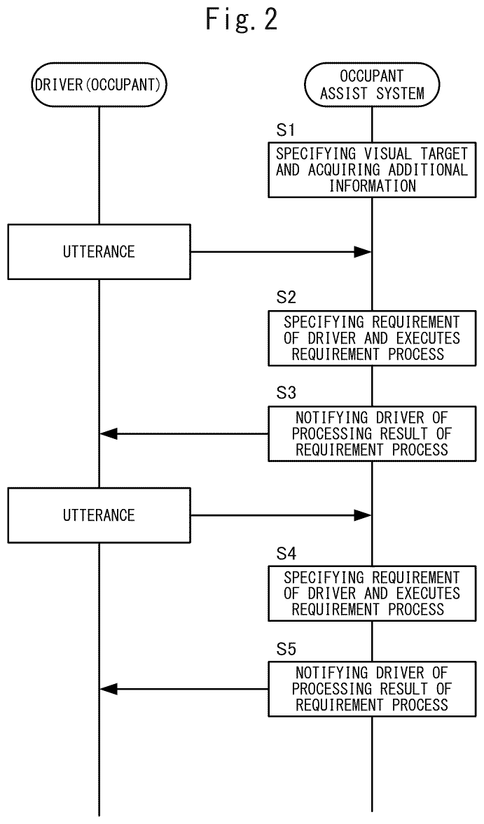

FIG. 2 is a view showing an example of an operation sequence of the occupant assist system 100.

At step S1, the occupant assist system 100 specifies the visual target of the driver based on the target around the vehicle and the line-of-sight direction of the driver, and acquires additional information regarding the visual target as needed.

At step S2, when a voice from the driver is detected via the microphone 422, the occupant assist system 100 specifies the requirement of the driver based on the content of the driver's voice, the visual target, and additional information of the visual target, and executes the requirement process for handling the requirement of the driver.

At step S3, the occupant assist system 100 notifies the driver (or vehicle occupant) of the processing result of the requirement process via the HMI 4.

At step S4, when the voice of the driver is detected via the microphone 422 within a predetermined period of time from the notification of the processing result, for example, the occupant assist system 100 specifies the additional requirement of the driver generated according to the processing result of the requirement process, and further executes the requirement process for handling the additional requirement.

At step S5, the occupant assist system 100 notifies the driver (or vehicle occupants) via the HMI 4 of the processing result that handled the additional requirements. By repeating the steps S4 and S5, the driver can repeatedly execute the interaction with the occupant assist system 100 until the driver can achieve the requirements for the shop related to the visual target even while driving.

The occupant assist system 100 according to the present embodiment explained above is configured to detect a target existing around the vehicle based on external environment data relating to an environment around the vehicle, detect a line-of-sight direction of the occupant based on occupant data representing a state of the occupant of the vehicle, specify a visual target viewed by the occupant based on the target and the line-of-sight direction of the occupant, acquire additional information related to the visual target when the type of the visual target is a building, and, based on a content of the occupant's voice when the occupant is looking at the visual target and additional information related to the visual target, specify a requirement for the visual target and perform an action to handle the requirement. The requirement for the visual target is, for example, a requirement related to a service provided at a store related to the visual target.

Due to this, even when the driver does not have information on the visual target such as the name of the shop, by combining the line-of-sight direction and the content of the driver's voice, the driver can take various actions such as a request for providing a service to the shop related to the visual target while continuing the travel without checking or searching for the visual target by stopping.

Further, the occupant assist system 100 according to the present embodiment is configured to notify a driver (occupant) of a result that handled the requirement via a HMI that is capable of exchanging information between the vehicle and the driver, and is configured to, when the driver issues a voice in response to a notification of the result, specify an additional requirement based on the content of the driver's voice and perform an action for handling the additional requirement.

In this way, the information required by the driver can be presented to the driver with high accuracy, and the requirements of the driver can be accurately dealt with.

Above, an embodiment of the present disclosure was explained, but the above embodiment only shows part of the examples of application of the present disclosure and is not intended to limit the technical scope of the present disclosure to the specific constitution of the embodiment.

For example, in the above embodiment, the requirement process is executed by the processing unit 63 of the control device 6, but some or all of the requirement process may be executed by an external server by performing communication with an external server via the communication device 5. In this case, the text data of the driver's voice, the visual target, and additional information of the visual target may be transmitted to an operator on the server side, and a part of the requirement process such as the reservation process may be performed by the operator. At this time, a voice call may be made with the operator, or the surrounding images received from the external camera 11 may be transmitted to the operator to share the surrounding images.

Further, in the above embodiment, the computer program run at the control device 6 may be provided in a computer readable portable storage medium such as a magnetic recording medium or optical recording medium.

1. An occupant assist system for assisting an occupant of a vehicle, wherein
the occupant assist system is configured to:
detect a target existing around the vehicle based on external environment data relating to an environment around the vehicle;
detect a line-of-sight direction of the occupant based on occupant data representing a state of the occupant of the vehicle;
specify a visual target viewed by the occupant based on the target and the line-of-sight direction of the occupant;
acquire additional information related to the visual target when the type of the visual target is a building; and,
based on a content of the occupant's voice when the occupant is looking at the visual target and additional information related to the visual target, specify a requirement of the occupant for the visual target and perform an action for handling the requirement.

2. The occupant assist system according to claim 1, is further configured to notify the occupant of a result that addressed the requirement via a HMI that is capable of exchanging information between the vehicle and the occupant.

3. The occupant assist system according to claim 2, is further configured to, when the occupant issues a voice in response to a notification of the result, specify an additional requirement based on the content of the occupant's voice and perform an action for handling the additional requirement.

4. The occupant assist system according to claim 1, wherein
the requirement is a requirement related to a service provided at a store related to the visual target.

5. An occupant assist method for assisting an occupant of a vehicle, comprising:
detecting a target existing around the vehicle based on external environment data relating to an environment around the vehicle;
detecting a line-of-sight direction of the occupant based on occupant data representing a state of the occupant of the vehicle;
specifying a visual target viewed by the occupant based on the target and the line-of-sight direction of the occupant;
acquiring additional information related to the visual target when the type of the visual target is a building; and,
based on a content of the occupant's voice when the occupant is looking at the visual target and additional information related to the visual target, specifying a requirement of the occupant for the visual target and performing an action for handling the requirement.
